(19) United States
(12) Patent Application Publication
(10) Pub. No.: US 2025/0368562 A1
(43) Pub. Date: Dec. 4, 2025

(54) OPTICAL GLASS, OPTICAL ELEMENT, LIGHT GUIDE PLATE AND IMAGE DISPLAY DEVICE

(71) Applicants: HOYA CORPORATION, Tokyo (JP); HOYA OPTICAL TECHNOLOGY (WEIHAI) CO., LTD., ShanDong (CN)

(72) Inventor: Hayato SASAKI, Tokyo (JP)

(73) Assignees: HOYA CORPORATION, Tokyo (JP); HOYA OPTICAL TECHNOLOGY (WEIHAI) CO., LTD., ShanDong (CN)

(21) Appl. No.: 19/198,216

(22) Filed: May 5, 2025

(30) Foreign Application Priority Data
May 29, 2024 (JP) 2024-087236
Mar. 10, 2025 (JP) 2025-037679

(51) Int. Cl. C03C 3/068; G02B 6/10; G02B 27/01

(52) U.S. Cl. CPC C03C 3/068; G02B 6/10; G02B 27/0172

(57) ABSTRACT

Provided is an optical glass, wherein, on a mass basis, a SiO₂ content is 1.00% or more, a B₂O₃ content is 1.00% or more, a CaO content is 1.00% or more, a TiO₂ content is 15.00% or more, a La₂O₃ content is 10.00% or more, a total content of SiO₂ and B₂O₃ is 22.00% or less, a total content of TiO₂ and Nb₂O₅ is 20.00% or more, a total content of MgO, CaO, SrO and BaO is 18.00% or less, a mass ratio of BaO content to the total content of MgO, CaO, SrO and BaO is 0.50 or less, a mass ratio of the TiO₂ content to the CaO content is 1.50 or more and 15.00 or less, and a mass ratio of the TiO₂ content to the total content of TiO₂ and Nb₂O₅ is 0.50 or more.

### CROSS-REFERENCE TO RELATED APPLICATIONS

This application claims priority under 35 U.S.C 119 to Japanese Patent Application No. 2024-087236 filed on May 29, 2024 and Japanese Patent Application No. 2025-037679 filed on Mar. 10, 2025. Each of the above applications is hereby expressly incorporated by reference, in its entirety.

### TECHNICAL FIELD

The present disclosure relates to an optical glass, an optical element, a light guide plate and an image display device.

### BACKGROUND ART

For example, Japanese Patent Application Publication No. 2024-3105, which is hereby expressly incorporated by reference, in its entirety, discloses an optical glass with a high refractive index.

### SUMMARY

For example, a lens comprised of optical glass with a high refractive index can be combined with other lenses comprised of glasses with different dispersion so as to form a cemented lens, and this enables the compactification of an optical system while correcting chromatic aberration. For this reason, such optical glass is useful as a material for optical elements that constitute imaging optical systems and projection optical systems such as projectors.

Light guide plates, which are components of image display devices, are also prepared from optical glass. Optical glass with a high refractive index can be used to prepare light guide plates with a wide viewing angle.

Furthermore, for the following reasons, a low specific gravity is also a desirable physical property for optical glass.

The refractive power of an optical element that constitutes an optical system is determined by the refractive index of the glass that constitutes the optical element and the curvature of the optical functional surface (the surface through which the light beam to be controlled enters and exits) of the optical element. When the curvature of the optical functional surface is increased, the thickness of the optical element also increases. As a result, the optical element becomes heavier. In contrast, where glass with a high refractive index is used, a large refractive power can be obtained without increasing the curvature of the optical functional surface.

It follows from the above that when the refractive index can be increased while suppressing the increase in the specific gravity of the glass, it is possible to reduce the weight of optical elements that have a certain refractive power.

Furthermore, a low specific gravity is also preferable for the glass that constitutes the light guide plate from the viewpoint of reducing the weight of the light guide plate and the weight of an image display device.

In view of the above, one aspect of the present disclosure provides for an optical glass that has a high refractive index and a low specific gravity.

One aspect of the present disclosure is as follows.

<1> An optical glass (hereinafter also simply referred to as “optical glass” or “glass”), wherein, on a mass basis,
a SiO₂ content is 1.00% or more,
a B₂O₃ content is 1.00% or more,
a CaO content is 1.00% or more,
a TiO₂ content is 15.00% or more,
a La₂O₃ content is 10.00% or more,
a total content of SiO₂ and B₂O₃ (SiO₂+B₂O₃) is 22.00% or less,
a total content of TiO₂ and Nb₂O₅ (TiO₂+Nb₂O₅) is 20.00% or more,
a total content of MgO, CaO, SrO and BaO (MgO+CaO+SrO+BaO) is 18.00% or less,
a mass ratio of BaO content to the total content of MgO, CaO, SrO and BaO (BaO/(MgO+CaO+SrO+BaO)) is 0.50 or less,
a mass ratio of the TiO₂ content to the CaO content (TiO₂/CaO) is 1.50 or more and 15.00 or less, and
a mass ratio of the TiO₂ content to the total content of TiO₂ and Nb₂O₅ (TiO₂/(TiO₂+Nb₂O₅)) is 0.50 or more.
   <2> The optical glass according to <1>, wherein a mass ratio of the SiO₂ content to the total content of SiO₂ and B₂O₃ (SiO₂/(SiO₂+B₂O₃)) is 0.05 or more and 0.80 or less.
   <3> The optical glass according to <1> or <2>, wherein a total content of Li₂O, Na₂O and K₂O (Li₂O+Na₂O+K₂O) is 5.00% or less.
   <4> The optical glass according to any one of <1> to <3>, wherein a total content of MgO, CaO, SrO, BaO and ZnO (MgO+CaO+SrO+BaO+ZnO) is 20.00% or less.
   <5> The optical glass according to any one of <1> to <4>, wherein a mass ratio of the CaO content to the total content of MgO, CaO, SrO and BaO (CaO/(MgO+CaO+SrO+BaO)) is 0.50 or more.
   <6> The optical glass according to any one of <1> to <5>, wherein a total content of Y₂O₃, La₂O₃ and Gd₂O₃ (Y₂O₃+La₂O₃+Gd₂O₃) is 10.00% or more.
   <7> The optical glass according to any one of <1> to <6>, wherein a mass ratio of a Y₂O₃ content to the total content of Y₂O₃, La₂O₃ and Gd₂O₃ (Y₂O₃/(Y₂O₃+La₂O₃+Gd₂O₃)) is 0.00 or more and 0.80 or less.
   <8> The optical glass according to any one of <1> to <7>, wherein a mass ratio of the total content of TiO₂ and Nb₂O₅ to the total content of Y₂O₃, La₂O₃ and Gd₂O₃ ((TiO₂+Nb₂O₅)/(Y₂O₃+La₂O₃+Gd₂O₃)) is 0.50 or more and 2.00 or less.
   <9> The optical glass according to <1>, wherein
a mass ratio of the SiO₂ content to the total content of SiO₂ and B₂O₃ (SiO₂/(SiO₂+B₂O₃)) is 0.20 or more and 0.80 or less,
a total content of Li₂O, Na₂O and K₂O (Li₂O+Na₂O+K₂O) is 5.00% or less,
a total content of MgO, CaO, SrO, BaO and ZnO (MgO+CaO+SrO+BaO+ZnO) is 20.00% or less,
a mass ratio of the CaO content to the total content of MgO, CaO, SrO and BaO (CaO/(MgO+CaO+SrO+BaO)) is 0.50 or more,
a total content of Y₂O₃, La₂O₃ and Gd₂O₃ (Y₂O₃+La₂O₃+Gd₂O₃) is 10.00% or more,
a mass ratio of the Y₂O₃ content to the total content of Y₂O₃, La₂O₃ and Gd₂O₃ (Y₂O₃/(Y₂O₃+La₂O₃+Gd₂O₃)) is 0.00 or more and 0.80 or less, and
a mass ratio of a total content of TiO₂ and Nb₂O₅ to the total content of Y₂O₃, La₂O₃ and Gd₂O₃ ((TiO₂+Nb₂O₅)/(Y₂O₃+La₂O₃+Gd₂O₃)) is 0.50 or more and 2.00 or less.
   <10> An optical element comprised of the optical glass according to any one of <1> to <9>.
   <11> A light guide plate comprised of the optical glass according to any one of <1> to <9>.
   <12> An image display device including:
an image display element, and
a light guide plate that guides light emitted from the image display element, wherein the light guide plate is the light guide plate according to <11>.

According to one aspect of the present disclosure, it is possible to provide an optical glass having a high refractive index and a low specific gravity.

According to other aspects of the present disclosure, it is possible to provide an optical element and a light guide plate comprised of the optical glass, and an image display device including the light guide plate.

### BRIEF DESCRIPTION OF THE DRAWINGS

FIG. 1 shows schematic diagrams of an example of an image device (head mounted display) including an image display element and a light guide plate; and

FIG. 2 shows a side view schematically showing the configuration of the head mounted display 1 shown in FIG. 1.

### DESCRIPTION OF THE EMBODIMENTS

### Optical Glass

### <Glass Composition>

In the present disclosure and this specification, the glass composition is expressed as an oxide-based glass composition. Here, the term “oxide-based glass composition” refers to a glass composition obtained by recalculation assuming that the glass raw materials have been completely decomposed during melting and are present as oxides in the glass. Unless otherwise specified, the glass composition is expressed on a mass basis (% by mass, mass ratio).

The glass composition in the present disclosure and this specification can be determined by a method such as ICP-AES (Inductively Coupled Plasma-Atomic Emission Spectrometry). Quantitative analysis is performed separately for each chemical element using ICP-AES. The analytical value is then converted to oxide notation. The analytical value by ICP-AES may contain a measurement error of, for example, about ±5% of the analytical value. Therefore, the oxide notation value converted from the analytical value may also contain an error of about ±5%.

Furthermore, in the present disclosure and this specification, the content of a constituent component being 0%, 0.0%, 0.00%, or not contained, or not introduced means that the constituent component is substantially not contained, and the content of the constituent component is about the impurity level or less. About the impurity level or less means, for example, less than 0.01%.

The glass composition of the optical glass will be described in more detail below.

The SiO₂ content is 1.00% or more, and can be 1.10% or more, 1.20% or more, 1.30% or more, 2.00% or more, 3.00% or more, 4.00% or more, 5.00% or more, 6.00% or more, or 7.00% or more, from the viewpoints of maintaining glass stability, maintaining viscosity suitable for molding molten glass, and suppressing a decrease in chemical durability.

The SiO₂ content can be 30.00% or less, 25.00% or less, 20.00% or less, 18.00% or less, 16.00% or less, 14.00% or less, 12.00% or less, 10.00% or less, or 8.00% or less, from the viewpoints of suppressing a decrease in the refractive index and maintaining glass meltability.

The B₂O₃ content is 1.00% or more, and can be 2.00% or more, 3.00% or more, 4.00% or more, 5.00% or more, 6.00% or more, 7.00% or more, or 8.00% or more, from the viewpoints of maintaining glass stability and maintaining a viscosity suitable for molding the molten glass.

The B₂O₃ content can be 30.00% or less, 25.00% or less, 20.00% or less, 18.00% or less, 16.00% or less, 14.00% or less, 12.00% or less, or 10.00% or less, from the viewpoint of suppressing a decrease in the refractive index and a decrease in chemical durability.

The total content of SiO₂ and B₂O₃ (SiO₂+B₂O₃) is 22.00% or less, and can be 21.00% or less, 20.00% or less, 19.00% or less, or 18.00% or less, from the viewpoint of suppressing a decrease in the refractive index.

The total content (SiO₂+B₂O₃) can be 2.00% or more, 4.00% or more, 6.00% or more, 8.00% or more, 10.00% or more, 11.00% or more, 12.00% or more, 13.00% or more, 14.00% or more, or 15.00% or more, from the viewpoint of maintaining glass stability.

The mass ratio of the SiO₂ content to the total content of SiO₂ and B₂O₃ (SiO₂/(SiO₂+B₂O₃)) can be 0.05 or more, 0.07 or more, 0.09 or more, 0.10 or more, 0.12 or more, 0.14 or more, 0.16 or more, 0.18 or more, 0.20 or more, 0.22 or more, 0.24 or more, 0.26 or more, 0.28 or more, 0.30 or more, 0.31 or more, 0.32 or more, 0.33 or more, 0.34 or more, 0.35 or more, 0.36 or more, 0.37 or more, 0.38 or more, 0.39 or more, or 0.40 or more, from the viewpoint of maintaining the thermal stability of the glass.

The mass ratio (SiO₂/(SiO₂+B₂O₃)) can be 0.80 or less, 0.75 or less, 0.70 or less, 0.65 or less, 0.60 or less, 0.59 or less, 0.58 or less, 0.57 or less, 0.56 or less, 0.55 or less, 0.54 or less, 0.53 or less, 0.52 or less, 0.51 or less, 0.50 or less, 0.49 or less, 0.48 or less, 0.47 or less, 0.46 or less, 0.45 or less, or 0.44 or less, from the viewpoint of maintaining the thermal stability of the glass.

The CaO content is 1.00% or more, and can be 2.00% or more, 2.50% or more, 3.00% or more, 3.50% or more, 4.00% or more, 4.50% or more, or 5.00% or more, from the viewpoint of improving the thermal stability and meltability of the glass.

The CaO content can be 20.00% or less, 18.00% or less, 16.00% or less, 15.00% or less, 14.00% or less, 13.00% or less, 12.00% or less, 11.00% or less, or 10.00% or less, from the viewpoint of suppressing a decrease in the refractive index.

The mass ratio of the BaO content to the total content of MgO, CaO, SrO and BaO (BaO/(MgO+CaO+SrO+BaO)) can be, for example, 0.00, 0.00 or more, more than 0.00 or 0.01 or more.

The mass ratio (BaO/(MgO+CaO+SrO+BaO)) is 0.50 or less, and can be 0.48 or less, 0.45 or less, 0.43 or less, 0.40 or less, 0.38 or less, 0.35 or less, 0.33 or less, 0.30 or less, 0.28 or less, 0.25 or less, 0.23 or less, or 0.20 or less, from the viewpoint of lowering the specific gravity while improving the meltability of the glass.

The mass ratio of the CaO content to the total content of MgO, CaO, SrO and BaO (CaO/(MgO+CaO+SrO+BaO)) can be 0.50 or more, 0.52 or more, 0.55 or more, 0.60 or more, 0.65 or more, or 0.70 or more, from the viewpoint of lowering the specific gravity while improving the meltability of the glass.

The mass ratio (CaO/(MgO+CaO+SrO+BaO)) can be, for example, 1.00, 1.00 or less, or less than 1.00, and can also be 0.90 or less, 0.80 or less, or 0.70 or less.

The total content of MgO, CaO, SrO and BaO (MgO+CaO+SrO+BaO) can be 1.00% or more, 2.00% or more, 3.00% or more, 4.00% or more, or 5.00% or more, from the viewpoints of improving the thermal stability of the glass and suppressing a decrease in the refractive index.

The total content (MgO+CaO+SrO+BaO) is 18.00% or less, and can be 17.00% or less, 16.00% or less, 15.00% or less, 14.00% or less, 13.00% or less, 12.00% or less, 11.00% or less, or 10.00% or less, from the viewpoints of improving the thermal stability of the glass and suppressing a decrease in the refractive index.

The total content of MgO, CaO, SrO, BaO and ZnO (MgO+CaO+SrO+BaO+ZnO) can be 20.00% or less, 19.00% or less, 18.00% or less, 17.00% or less, 16.00% or less, 15.00% or less, 14.00% or less, 13.00% or less, 12.00% or less, 11.00% or less, or 10.00% or less, from the viewpoints of improving the thermal stability of the glass and suppressing a decrease in the refractive index.

The total content (MgO+CaO+SrO+BaO+ZnO) can be, for example, 1.00% or more, 2.00% or more, 3.00% or more, 4.00% or more, or 5.00% or more.

The respective contents of MgO, SrO and BaO can be 0.00%, 0.00% or more, more than 0.00%, 0.05% or more, or 0.10% or more. Furthermore, the respective contents of MgO, SrO and BaO can be, for example, 10.00% or less, 9.00% or less, 8.00% or less, 7.00% or less, 6.00% or less, 5.00% or less, 4.00% or less, 3.00% or less, 2.00% or less, or 1.00% or less.

MgO, SrO and BaO all act to improve the thermal stability of the glass, but as the contents thereof increase, the refractive index tends to decrease. For this reason, the respective contents of MgO, SrO and BaO can be within the above ranges.

The ZnO content can be 0.00%, 0.00% or more, more than 0.00%, 0.10% or more, or 0.10% or more. Furthermore, the ZnO content can be, for example, 10.00% or less, 9.00% or less, 8.00% or less, 7.00% or less, 6.00% or less, 5.00% or less, 4.00% or less, 3.00% or less, or 2.00% or less.

ZnO acts to improve the thermal stability of the glass, but as the ZnO content increases, the specific gravity tends to increase. Therefore, the ZnO content can be in the above range.

The TiO₂ content is 15.00% or more, and can be 18.00% or more, 20.00% or more, 21.00% or more, 22.00% or more, 23.00% or more, 24.00% or more, 25.00% or more, 26.00% or more, or 27.00% or more, from the viewpoints of increasing the refractive index of the glass and improving the chemical durability,

The TiO₂ content can be 50.00% or less, 45.00% or less, 40.00% or less, 38.00% or less, 36.00% or less, 35.00% or less, 34.00% or less, 33.00% or less, 32.00% or less, 31.00% or less, or 30.00% or less, from the viewpoint of suppressing a decrease in glass stability.

The mass ratio of the TiO₂ content to the CaO content (TiO₂/CaO) is 1.50 or more, and can be 1.80 or more, 1.90 or more, 2.00 or more, 2.10 or more, 2.20 or more, 2.30 or more, 2.40 or more, 2.50 or more, 2.60 or more, 2.70 or more, 2.80 or more, 2.90 or more, 3.00 or more, 3.10 or more, 3.20 or more, 3.30 or more, 3.40 or more, 3.50 or more, 3.60 or more, 3.70 or more, 3.80 or more, 3.90 or more, or 4.00 or more, from the viewpoints of increasing the refractive index of the glass and improving the thermal stability.

The mass ratio (TiO₂/CaO) is 15.00 or less, and can be 14.00 or less, 13.00 or less, 12.00 or less, 11.00 or less, 10.00 or less, 9.00 or less, 8.00 or less, 7.00 or less, 6.00 or less, or 5.00 or less, from the viewpoints of increasing the refractive index of the glass and improving the thermal stability.

The total content of TiO₂ and Nb₂O₅ (TiO₂+Nb₂O₅) is 20.00% or more, and can be 21.00% or more, 22.00% or more, 23.00% or more, 24.00% or more, 25.00% or more, 26.00% or more, or 27.00% or more, from the viewpoint of suppressing a decrease in the refractive index.

The total content (TiO₂+Nb₂O₅) can be 50.00% or less, 45.00% or less, 40.00% or less, 39.00% or less, 38.00% or less, 37.00% or less, 36.00% or less, 35.00% or less, 34.00% or less, 33.00% or less, 32.00% or less, or 31.00% or less, from the viewpoint of maintaining glass stability.

The mass ratio of the TiO₂ content to the total content of TiO₂ and Nb₂O₅ (TiO₂/(TiO₂+Nb₂O₅)) is 0.50 or more, and can be 0.55 or more, 0.60 or more, 0.65 or more, 0.70 or more, 0.75 or more, 0.80 or more, 0.82 or more, 0.84 or more, 0.86 or more, 0.88 or more, or 0.90 or more, from the viewpoint of further increasing the refractive index and further decreasing the specific gravity of the glass.

The mass ratio (TiO₂/(TiO₂+Nb₂O₅)) can be, for example, 1.00, 1.00 or less, or less than 1.00.

The Nb₂O₅ content can be 0.00%, 0.00% or more, more than 0.00%, 0.10% or more, 0.50% or more, 1.00% or more, 1.50% or more, 2.00% or more, 2.50% or more, 3.00% or more, 3.50% or more, 4.00% or more, 4.50% or more, or 5.00% or more.

The Nb₂O₅ content can be, for example, 20.00% or less, 18.00% or less, 15.00% or less, 14.00% or less, 13.00% or less, 12.00% or less, 11.00% or less, or 10.00% or less.

The Nb₂O₅ content can be in the above range from the viewpoint of increasing the refractive index of the glass and improving the chemical durability.

The La₂O₃ content is 10.00% or more, and can be 15.00% or more, 18.00% or more, 20.00% or more, 22.00% or more, 24.00% or more, 26.00% or more, 28.00% or more, 30.00% or more, 31.00% or more, 32.00% or more, 33.00% or more, 34.00% or more, or 35.00% or more, from the viewpoint of increasing the refractive index of the glass, maintaining low dispersion, and improving chemical durability.

The La₂O₃ content can be 60.00% or less, 55.00% or less, 50.00% or less, 48.00% or less, 46.00% or less, 44.00% or less, 42.00% or less, or 40.00% or less, from the viewpoint of suppressing a decrease in glass stability.

The Y₂O₃ content can be 0.00%, 0.00% or more, or more than 0.00%. Furthermore, the Y₂O₃ content can be, for example, 15.00% or less, 13.00% or less, 10.00% or less, 8.00% or less, 5.00% or less, 4.00% or less, 3.00% or less, 2.00% or less, 1.00% or less, 0.50% or less, or 0.10% or less, or can be 0.00%.

The Y₂O₃ content can be in the above range from the viewpoint of increasing the refractive index of the glass, maintaining low dispersion, and improving chemical durability. Furthermore, Y₂O₃ has a low specific gravity among rare earth oxides. The Y₂O₃ content can be in the above range from the viewpoint of reducing the specific gravity of the glass.

The Gd₂O₃ content can be 0.00%, 0.00% or more, or more than 0.00%. Furthermore, the Gd₂O₃ content can be, for example, 10.00% or less, 8.00% or less, 5.00% or less, 4.00% or less, 3.00% or less, 2.00% or less, 1.00% or less, 0.50% or less, or 0.10% or less, or can be 0.00%.

The Gd₂O₃ content can be in the above range from the viewpoint of increasing the refractive index of the glass, maintaining low dispersion, and improving chemical durability.

The Yb₂O₃ content can be 0.00%, 0.00% or more, or more than 0.00%. Furthermore, the Yb₂O₃ content can be, for example, 10.00% or less, 8.00% or less, 5.00% or less, 4.00% or less, 3.00% or less, 2.00% or less, 1.00% or less, 0.50% or less, or 0.10% or less, or can be 0.00%.

The Yb₂O₃ content can be in the above range from the viewpoint of increasing the refractive index of the glass, maintaining low dispersion, and improving chemical durability.

The total content of Y₂O₃, La₂O₃ and Gd₂O₃ (Y₂O₃+La₂O₃+Gd₂O₃) can be 10.00% or more, 15.00% or more, 20.00% or more, 23.00% or more, 25.00% or more, 28.00% or more, 30.00% or more, 33.00% or more, or 35.00% or more, from the viewpoint of increasing the refractive index while maintaining the low dispersion of the glass.

The total content (Y₂O₃+La₂O₃+Gd₂O₃) can be, for example, 70.00% or less, 60.00% or less, 55.00% or less, 50.00% or less, 45.00% or less, 44.00% or less, 43.00% or less, 42.00% or less, 41.00% or less, or 40.00% or less.

The mass ratio of the Y₂O₃ content to the total content of Y₂O₃, La₂O₃ and Gd₂O₃ (Y₂O₃/(Y₂O₃+La₂O₃+Gd₂O₃)) can be 0.00 or more, 0.01 or more, 0.02 or more, 0.03 or more, 0.04 or more, 0.05 or more, 0.08 or more, 0.10 or more, 0.13 or more, 0.15 or more, 0.18 or more, or 0.20 or more.

The mass ratio (Y₂O₃/(Y₂O₃+La₂O₃+Gd₂O₃)) can be 0.80 or less, 0.75 or less, 0.70 or less, 0.65 or less, 0.60 or less, 0.55 or less, 0.50 or less, 0.48 or less, 0.45 or less, 0.43 or less, 0.40 or less, 0.38 or less, 0.35 or less, 0.33 or less, or 0.30 or less.

The mass ratio (Y₂O₃/(Y₂O₃+La₂O₃+Gd₂O₃)) can be in the above range from the viewpoint of lowering the specific gravity while increasing the refractive index of the glass.

The mass ratio of the total content of TiO₂ and Nb₂O₅ to the total content of Y₂O₃, La₂O₃ and Gd₂O₃ ((TiO₂+Nb₂O₅)/(Y₂O₃+La₂O₃+Gd₂O₃)) can be 0.50 or more, 0.53 or more, 0.55 or more, 0.58 or more, 0.60 or more, 0.63 or more, 0.65 or more, 0.68 or more, 0.70 or more, 0.73 or more, 0.75 or more, 0.78 or more, 0.80 or more, 0.83 or more, or 0.85 or more.

The mass ratio ((TiO₂+Nb₂O₅)/(Y₂O₃+La₂O₃+Gd₂O₃)) can be 2.00 or less, 1.90 or less, 1.80 or less, 1.70 or less, 1.60 or less, 1.55 or less, 1.50 or less, 1.45 or less, 1.40 or less, 1.35 or less, 1.30 or less, 1.25 or less, 1.20 or less, 1.15 or less, 1.10 or less, 1.05 or less, or 1.00 or less.

The mass ratio ((TiO₂+Nb₂O₅)/(Y₂O₃+La₂O₃+Gd₂O₃)) can be in the above range from the viewpoint of increasing the refractive index while maintaining the thermal stability of the glass.

The total content of Li₂O, Na₂O and K₂O (Li₂O+Na₂O+K₂O) can be 0.00%, 0.00% or more, or more than 0.00%.

The total content (Li₂O+Na₂O+K₂O) can be 5.00% or less, 4.00% or less, 3.00% or less, 2.00% or less, or 1.00% or less, and can be 0.00% from the viewpoint of suppressing a decrease in the refractive index and a decrease in chemical durability.

The Li₂O content can be 0.00%, 0.00% or more, or more than 0.00%. Furthermore, the Li₂O content can be, for example, 5.00% or less, 4.00% or less, 3.00% or less, 2.00% or less, or 1.00% or less, or can be 0.00%.

The Na₂O content can be 0.00%, 0.00% or more, or more than 0.00%. Furthermore, the Na₂O content can be, for example, 5.00% or less, 4.00% or less, 3.00% or less, 2.00% or less, or 1.00% or less, or can be 0.00%.

The K₂O content can be 0.00%, 0.00% or more, or more than 0.00%. Furthermore, the K₂O content can be, for example, 5.00% or less, 4.00% or less, 3.00% or less, 2.00% or less, or 1.00% or less, or can be 0.00%.

The ZrO₂ content can be 0.00% or 0.00% or more, more than 0.00%, 0.50% or more, 1.00% or more, 2.00% or more, 3.00% or more, 4.00% or more, or 5.00% or more, from the viewpoints of increasing the refractive index of the glass and improving chemical durability. The ZrO₂ content can be 15.00% or less, 13.00% or less, 10.00% or less, or 8.00% or less, from the viewpoint of suppressing a decrease in glass stability.

The Ta₂O₅ content can be 0.00%, 0.00% or more, more than 0.00%, 0.10% or more, or 0.10% or more. Furthermore, the Ta₂O₅ content can be, for example, 5.00% or less, 4.00% or less, 3.00% or less, 2.00% or less, or 1.00% or less, or can be 0.00%.

Ta₂O₅ can contribute to increasing the refractive index and improving chemical durability of the glass. Meanwhile, Ta₂O₅ is expensive, and glass stability tends to decrease as the Ta₂O₅ content increases. From these viewpoints, the Ta₂O₅ content can be in the above range.

The optical glass may further contain one or more of P₂O₅, Al₂O₃, and the like, in addition to the above components.

The P₂O₅ content can be 0.00% or more, and can be 10.00% or less, 8.00% or less, 6.00% or less, 4.00% or less, 2.00% or less, 1.00% or less, or 0.50% or less, and can be 0.00%.

The Al₂O₃ content can be 0.00% or more, and can be 10.00% or less, 8.00% or less, 6.00% or less, 4.00% or less, 2.00% or less, 1.00% or less, or 0.50% or less, and can be 0.00%.

Pb, As, Cd, TI, Be, and Se are all toxic. It is possible not to include these chemical elements, that is, not to introduce these chemical elements into the glass as glass components.

U, Th, and Ra are all radioactive chemical elements. It is possible not to include these chemical elements, that is, not to introduce these chemical elements into the glass as glass components.

V, Cr, Mn, Fe, Co, Ni, Cu, Pr, Nd, Pm, Sm, Eu, Tb, Dy, Ho, Er, Tm, and Ce are undesirable chemical elements to be contained in glass for optical elements, as these chemical elements increase the coloring of the glass and are sources of fluorescence. It is possible not to include these chemical elements, that is, not to introduce these chemical elements into the glass as glass components.

Sb and Sn are optional chemical elements that function as fining agents.

The amount of Sb added, as converted to Sb₂O₃, can be in the range of 0.000% by mass to 0.100% by mass, in the range of 0.001% by mass to 0.020% by mass, or in the range of 0.001% by mass to 0.010% by mass when the total content of glass components other than Sb₂O₃ is taken as 100% by mass.

The amount of Sn added, as converted to SnO₂, can be in the range of 0.000% by mass to 0.100% by mass, in the range of 0.000% by mass to 0.020% by mass, in the range of 0.000% by mass to 0.010% by mass, or in the range of 0.000% by mass to 0.005% by mass when the total content of glass components other than SnO₂ is taken as 100% by mass.

### <Glass Physical Properties>

### Refractive Index nd

The refractive index nd of the optical glass can be greater than 1.90000, 1.95000 or more, 1.96000 or more, 1.97000 or more, 1.98000 or more, 1.99000 or more, or 2.00000 or more. The refractive index nd of the optical glass can be, for example, 2.20000 or less, 2.15000 or less, 2.14000 or less, 2.13000 or less, 2.12000 or less, 2.11000 or less, or 2.10000 or less. In the present disclosure and this specification, “refractive index” means “refractive index nd”.

### Abbe Number vd

The Abbe number vd is a value that indicates the property related to dispersion, and is expressed as vd=(nd−1)/(nF−nC) using the refractive indices nd, nF, and nC at the d-line, F-line, and C-line. From the viewpoint of usefulness as a material for optical elements and a light guide plate material, the Abbe number vd of the optical glass can be 20.00 or more, 21.00 or more, 22.00 or more, or 23.00 or more. From the same viewpoint, the Abbe number vd can be 30.00 or less, 29.00 or less, 28.00 or less, 27.00 or less, 26.00 or less, 25.00 or less, or 24.00 or less.

### Specific Gravity

The specific gravity of the optical glass can be 5.00 g/cc or less, 4.80 g/cc or less, 4.60 g/cc or less, 4.50 g/cc or less, or 4.40 g/cc or less. Since a lower specific gravity is preferable from the viewpoint of reducing the weight of optical elements, there is no particular lower limit for the specific gravity of the optical glass. In one embodiment, the specific gravity can be 4.00 g/cc or more, 4.10 g/cc or more, or 4.20 g/cc or more.

The optical glass described above is useful as a glass material for optical elements and a glass material for light guide plates.

### <Method for Manufacturing Optical Glass>

The optical glass can be obtained, for example, by the following method. Raw materials such as oxides, carbonates, sulfates, nitrates, and hydroxides are weighed and compounded so as to obtain the desired glass composition and then mixed thoroughly to obtain a mixed batch. The mixed batch is heated, melted, degassed, and stirred in a melting vessel to prepare a homogeneous, bubble-free molten glass. Specifically, the molten glass can be prepared using a known melting method. The molten glass thus obtained can be molded to prepare the optical glass.

### Glass Material for Press Molding, Optical Element Blank, and Manufacturing Methods Thereof

Another aspect of the present disclosure relates to:
a glass material for press molding comprised of the optical glass; and
an optical element blank comprised of the optical glass.

According to other aspects of the present disclosure, there are also provided:
a method for manufacturing a glass material for press molding, including a step of molding the optical glass into a glass material for press molding;
a method for manufacturing an optical element blank, including a step of press molding the glass material for optical glass press molding using a press mold to prepare an optical element blank; and
a method for manufacturing an optical element blank, including a step of molding the optical glass into an optical element blank.

An optical element blank is an optical element base material that approximates the shape of a target optical element and includes a polishing allowance (a surface layer to be removed by polishing), and, if necessary, also includes a grinding allowance (a surface layer to be removed by grinding) added to the shape of the optical element. The optical element is finished by grinding and polishing the surface of the optical element blank. In one embodiment, an optical element blank can be prepared by a method (called a direct press method) in which a molten glass obtained by melting a suitable amount of the above glass is press-molded. In another embodiment, an optical element blank can be prepared by solidifying a molten glass obtained by melting a suitable amount of the above glass.

In yet another embodiment, an optical element blank can be prepared by preparing a glass material for press molding and press molding the prepared glass material for press molding.

Press molding of a glass material for press molding can be carried out by a known method in which a glass material for press molding that has been softened by heating is pressed in a press mold. Both heating and press molding can be carried out in air. A homogeneous optical element blank can be obtained by annealing after press molding to reduce strains inside the glass.

Glass materials for press molding include glass gobs for press molding that are used for press molding to prepare optical element blanks as they are, as well as glass gobs for press molding that are machined by cutting, grinding, polishing, and the like, and then used for press molding. Cutting methods include a method in which a groove is formed in the portion of the surface of the glass plate to be cut by a method called scribing, and local pressure is applied to the grooved portion from the back side of the surface on which the groove is formed, thereby breaking the glass plate at the grooved portion, a method in which the glass plate is cut with a cutting blade, and the like. Grinding and polishing methods include barrel polishing, and the like.

Glass materials for press molding can be prepared, for example, by casting molten glass into a casting mold to form a glass plate and cutting this glass plate into multiple glass pieces. Alternatively, a suitable amount of molten glass can be molded to prepare a glass gob for press molding. An optical element blank can also be prepared by reheating and softening a glass gob for press molding and press molding the softened glass gob. The method for preparing an optical element blank by reheating and softening glass and press molding the softened glass is called the reheat press method as opposed to the direct press method.

### Optical Element and Manufacturing Method Thereof

Another aspect of the present disclosure relates to:
an optical element comprised of the optical glass.
The optical element is prepared using the optical glass. In the optical element, the glass surface may be provided with one or more layers of coating, such as a multilayer film such as an anti-reflection film.

According to another aspect of the present disclosure, there is also provided a method for manufacturing an optical element, including a step of grinding and/or polishing the optical element blank described above to prepare an optical element.

In the method for manufacturing an optical element, well-known methods can bd adopted for grinding and polishing, and an optical element with high internal quality and surface quality can be obtained by thoroughly cleaning and drying the optical element surface after machining. In this manner, an optical element comprised of the glass described above can be obtained. Examples of optical elements include various lenses such as spherical lenses, aspherical lenses, and microlenses, as well as prisms and the like.

Furthermore, optical elements comprised of the optical glass are also suitable as lenses that constitute a cemented optical element. Examples of cemented optical elements include those in which lenses are cemented together (cemented lenses), those in which a lens is cemented to a prism, and the like. For example, a cemented optical element can be prepared by precisely machining (for example, spherical polishing) the cementing surfaces of two optical elements to be cemented so that they have inverted shapes, applying an ultraviolet-curable adhesive used for cementing cemented lenses, bonding the lenses together, and then radiating ultraviolet rays through the lenses to cure the adhesive. The above glass is preferable for preparing a cemented optical element in this way. By preparing a plurality of optical elements to be cemented using a plurality of types of glass with different Abbe numbers vd and cementing the optical elements together, an element suitable for correcting chromatic aberration can be prepared.

### Light Guide Plate and Image Display Device

Other aspects of the present disclosure relate to:
a light guide plate comprised of the optical glass; and
an image display device including an image display element and a light guide plate that guides light emitted from the image display element, wherein the light guide plate is the light guide plate comprised of any of the optical glasses describe above.

A specific embodiment of the image display device will be described hereinbelow.

### EXAMPLES

The present disclosure will be described hereinbelow in more detail with reference to Examples. However, the present disclosure is not limited to the embodiments shown in Examples.

### Example 1

The corresponding nitrates, sulfates, carbonates, hydroxides, oxides, boric acid, and the like were used as raw materials for introducing each component to obtain the glass composition shown in the tables below, and the raw materials were weighed and thoroughly mixed to prepare a compounded raw material.

The compounded raw material was placed in a platinum crucible and heated to melt. After melting, the molten glass was poured into a casting mold and allowed to cool to near the glass transition temperature, and then immediately placed in an annealing furnace. The glass was annealed for about 1 h within the glass transition temperature range and then allowed to cool to room temperature in the furnace. In this manner, optical glasses No. 1 to 51 as shown in the tables below were obtained. In the tables below, the unit of content is percent by mass. The Sb₂O₃ content is the content when the total content of glass components other than Sb₂O₃ is taken as 100% by mass.

Various physical properties of the optical glasses in Example 1 are shown in the tables below. The physical properties of the optical glasses were measured by the following methods.

### Evaluation of Physical Properties of Optical Glasses

### (1) Refractive Index nd and Abbe Number vd

The refractive index nd and Abbe number vd of the glasses obtained by lowering the temperature at a rate of −30° C./h were measured using the refractive index measurement method specified by the standard of the Japan Optical Glass Manufacturers' Association.

### (2) Specific Gravity

Specific gravity was measured using the Archimedes method.

The above results are shown in the tables below.

TABLE 1

| No. | 1 | 2 | 3 | 4 | 5 | 6 |
|---|---|---|---|---|---|---|
| SiO₂ | 7.18 | 6.82 | 6.86 | 6.90 | 6.94 | 6.98 |
| B₂O₃ | 10.21 | 9.43 | 9.49 | 9.54 | 9.60 | 9.65 |
| Li₂O | 0.00 | 0.00 | 0.00 | 0.00 | 0.00 | 0.00 |
| Na₂O | 0.00 | 0.00 | 0.00 | 0.00 | 0.00 | 0.00 |
| K₂O | 0.00 | 0.00 | 0.00 | 0.00 | 0.00 | 0.00 |
| MgO | 0.00 | 0.00 | 0.00 | 0.00 | 0.00 | 0.00 |
| CaO | 6.68 | 6.35 | 6.39 | 6.42 | 6.46 | 6.50 |
| SrO | 0.00 | 0.00 | 0.00 | 0.00 | 0.00 | 0.00 |
| BaO | 0.00 | 0.00 | 0.00 | 0.00 | 0.00 | 0.00 |
| ZnO | 1.37 | 1.30 | 1.31 | 1.32 | 1.33 | 1.33 |
| TiO₂ | 29.89 | 22.55 | 22.68 | 22.81 | 22.95 | 23.08 |
| Nb₂O₅ | 0.00 | 9.23 | 9.29 | 9.34 | 9.39 | 9.45 |
| WO₃ | 0.00 | 0.00 | 0.00 | 0.00 | 0.00 | 0.00 |
| ZrO₂ | 7.65 | 7.27 | 7.31 | 7.35 | 7.40 | 7.44 |
| Y₂O₃ | 0.00 | 0.00 | 1.31 | 2.63 | 3.97 | 5.33 |
| La₂O₃ | 37.01 | 37.04 | 35.37 | 33.68 | 31.97 | 30.23 |
| Gd₂O₃ | 0.00 | 0.00 | 0.00 | 0.00 | 0.00 | 0.00 |
| Yb₂O₃ | 0.00 | 0.00 | 0.00 | 0.00 | 0.00 | 0.00 |
| Ta₂O₅ | 0.00 | 0.00 | 0.00 | 0.00 | 0.00 | 0.00 |
| Sb₂O₃ | 0.01 | 0.01 | 0.01 | 0.01 | 0.01 | 0.01 |
| Total | 100.01 | 100.01 | 100.01 | 100.01 | 100.01 | 100.01 |
| SiO₂ + B₂O₃ | 17.39 | 16.26 | 16.35 | 16.44 | 16.54 | 16.64 |
| MgO + CaO + SrO + BaO | 6.68 | 6.35 | 6.39 | 6.42 | 6.46 | 6.50 |
| BaO/(MgO + CaO + SrO + BaO) | 0.00 | 0.00 | 0.00 | 0.00 | 0.00 | 0.00 |
| TiO₂ + Nb₂O₅ | 29.89 | 31.78 | 31.97 | 32.15 | 32.34 | 32.53 |
| TiO₂/CaO | 4.473 | 3.551 | 3.551 | 3.551 | 3.551 | 3.551 |
| TiO₂/(TiO₂ + Nb₂O₅) | 1.000 | 0.710 | 0.710 | 0.710 | 0.710 | 0.710 |
| SiO₂/(SiO₂ + B₂O₃) | 0.41 | 0.42 | 0.42 | 0.42 | 0.42 | 0.42 |
| Li₂O + Na₂O + K₂O | 0.00 | 0.00 | 0.00 | 0.00 | 0.00 | 0.00 |
| MgO + CaO + SrO + BaO + ZnO | 8.05 | 7.65 | 7.70 | 7.74 | 7.79 | 7.83 |
| CaO/(MgO + CaO + SrO + BaO) | 1.00 | 1.00 | 1.00 | 1.00 | 1.00 | 1.00 |
| Y₂O₃ + La₂O₃ + Gd₂O₃ | 37.01 | 37.04 | 36.68 | 36.31 | 35.94 | 35.56 |
| Y₂O₃/(Y₂O₃ + La₂O₃ + Gd₂O₃) | 0.00 | 0.00 | 0.04 | 0.07 | 0.11 | 0.15 |
| (TiO₂ + Nb₂O₅)/(Y₂O₃ + La₂O₃ + Gd₂O₃) | 0.81 | 0.86 | 0.87 | 0.89 | 0.90 | 0.91 |
| nd | 2.00939 | 2.00686 | 2.00612 | 2.00491 | 2.00388 | 2.00262 |
| vd | 24.33 | 25.18 | 25.15 | 25.11 | 25.10 | 25.11 |
| Specific gravity (g/cc) | 4.33 | 4.45 | 4.43 | 4.41 | 4.40 | 4.38 |

TABLE 2

| No. | 7 | 8 | 9 | 10 | 11 | 12 |
|---|---|---|---|---|---|---|
| SiO₂ | 6.86 | 6.89 | 6.89 | 6.96 | 6.86 | 6.90 |
| B₂O₃ | 10.28 | 11.14 | 9.52 | 9.61 | 9.49 | 9.54 |
| Li₂O | 0.00 | 0.00 | 0.35 | 0.70 | 0.00 | 0.00 |
| Na₂O | 0.00 | 0.00 | 0.00 | 0.00 | 0.72 | 1.44 |
| K₂O | 0.00 | 0.00 | 0.00 | 0.00 | 0.00 | 0.00 |
| MgO | 0.00 | 0.00 | 0.00 | 0.00 | 0.00 | 0.00 |
| CaO | 5.08 | 3.80 | 5.11 | 3.84 | 5.09 | 3.81 |
| SrO | 0.00 | 0.00 | 0.00 | 0.00 | 0.00 | 0.00 |
| BaO | 0.00 | 0.00 | 0.00 | 0.00 | 0.00 | 0.00 |
| ZnO | 1.31 | 1.32 | 1.32 | 1.33 | 1.31 | 1.32 |
| TiO₂ | 22.66 | 22.77 | 22.77 | 22.99 | 22.68 | 22.81 |
| Nb₂O₅ | 9.28 | 9.32 | 9.32 | 9.41 | 9.29 | 9.34 |
| WO₃ | 0.00 | 0.00 | 0.00 | 0.00 | 0.00 | 0.00 |
| ZrO₂ | 7.30 | 7.34 | 7.34 | 7.41 | 7.31 | 7.35 |
| Y₂O₃ | 0.00 | 0.00 | 0.00 | 0.00 | 0.00 | 0.00 |
| La₂O₃ | 37.23 | 37.41 | 37.40 | 37.76 | 37.26 | 37.48 |
| Gd₂O₃ | 0.00 | 0.00 | 0.00 | 0.00 | 0.00 | 0.00 |
| Yb₂O₃ | 0.00 | 0.00 | 0.00 | 0.00 | 0.00 | 0.00 |
| Ta₂O₅ | 0.00 | 0.00 | 0.00 | 0.00 | 0.00 | 0.00 |
| Sb₂O₃ | 0.01 | 0.01 | 0.01 | 0.01 | 0.01 | 0.01 |
| Total | 100.01 | 100.01 | 100.01 | 100.01 | 100.01 | 100.01 |
| SiO₂ + B₂O₃ | 17.14 | 18.04 | 16.41 | 16.57 | 16.35 | 16.45 |
| MgO + CaO + SrO + BaO | 5.08 | 3.80 | 5.11 | 3.84 | 5.09 | 3.81 |
| BaO/(MgO + CaO + SrO + BaO) | 0.00 | 0.00 | 0.00 | 0.00 | 0.00 | 0.00 |
| TiO₂ + Nb₂O₅ | 31.94 | 32.10 | 32.09 | 32.40 | 31.97 | 32.15 |
| TiO₂/CaO | 4.458 | 5.987 | 4.458 | 5.987 | 4.458 | 5.987 |
| TiO₂/(TiO₂ + Nb₂O₅) | 0.710 | 0.710 | 0.710 | 0.710 | 0.710 | 0.710 |
| SiO₂/(SiO₂ + B₂O₃) | 0.40 | 0.38 | 0.42 | 0.42 | 0.42 | 0.42 |
| Li₂O + Na₂O + K₂O | 0.00 | 0.00 | 0.35 | 0.70 | 0.72 | 1.44 |
| MgO + CaO + SrO + BaO + ZnO | 6.39 | 5.12 | 6.42 | 5.17 | 6.40 | 5.13 |
| CaO/(MgO + CaO + SrO + BaO) | 1.00 | 1.00 | 1.00 | 1.00 | 1.00 | 1.00 |
| Y₂O₃ + La₂O₃ + Gd₂O₃ | 37.23 | 37.41 | 37.40 | 37.76 | 37.26 | 37.48 |
| Y₂O₃/(Y₂O₃ + La₂O₃ + Gd₂O₃) | 0.00 | 0.00 | 0.00 | 0.00 | 0.00 | 0.00 |
| (TiO₂ + Nb₂O₅)/(Y₂O₃ + La₂O₃ + Gd₂O₃) | 0.86 | 0.86 | 0.86 | 0.86 | 0.86 | 0.86 |
| nd | 2.00649 | 2.00537 | 2.01056 | 2.01308 | 2.00501 | 2.00239 |
| vd | 25.01 | 24.87 | 24.98 | 24.81 | 25.00 | 24.83 |
| Specific gravity (g/cc) | 4.44 | 4.43 | 4.46 | 4.46 | 4.45 | 4.43 |

TABLE 3

| No. | 13 | 14 | 15 | 16 | 17 | 18 |
|---|---|---|---|---|---|---|
| SiO₂ | 7.02 | 8.16 | 5.47 | 8.41 | 7.03 | 7.06 |
| B₂O₃ | 9.71 | 8.58 | 10.29 | 9.66 | 10.54 | 9.76 |
| Li₂O | 1.06 | 0.00 | 0.00 | 0.00 | 0.00 | 0.36 |
| Na₂O | 0.00 | 0.00 | 0.00 | 0.00 | 0.00 | 0.00 |
| K₂O | 0.00 | 0.00 | 0.00 | 0.00 | 0.00 | 0.00 |
| MgO | 0.00 | 0.00 | 0.00 | 0.00 | 0.00 | 0.00 |
| CaO | 2.55 | 6.31 | 6.39 | 6.50 | 6.54 | 6.57 |
| SrO | 0.00 | 0.00 | 0.00 | 0.00 | 0.00 | 0.00 |
| BaO | 0.00 | 0.00 | 0.00 | 0.00 | 0.00 | 0.00 |
| ZnO | 1.34 | 1.30 | 1.31 | 1.33 | 1.34 | 1.35 |
| TiO₂ | 23.21 | 22.42 | 22.68 | 23.10 | 23.24 | 23.35 |
| Nb₂O₅ | 9.50 | 9.18 | 9.29 | 9.46 | 9.51 | 9.56 |
| WO₃ | 0.00 | 0.00 | 0.00 | 0.00 | 0.00 | 0.00 |
| ZrO₂ | 7.48 | 7.23 | 7.31 | 7.44 | 7.49 | 7.52 |
| Y₂O₃ | 0.00 | 0.00 | 0.00 | 0.00 | 0.00 | 0.00 |
| La₂O₃ | 38.13 | 36.83 | 37.26 | 34.10 | 34.30 | 34.47 |
| Gd₂O₃ | 0.00 | 0.00 | 0.00 | 0.00 | 0.00 | 0.00 |
| Yb₂O₃ | 0.00 | 0.00 | 0.00 | 0.00 | 0.00 | 0.00 |
| Ta₂O₅ | 0.00 | 0.00 | 0.00 | 0.00 | 0.00 | 0.00 |
| Sb₂O₃ | 0.01 | 0.01 | 0.01 | 0.01 | 0.01 | 0.01 |
| Total | 100.01 | 100.01 | 100.01 | 100.01 | 100.01 | 100.01 |
| SiO₂ + B₂O₃ | 16.73 | 16.74 | 15.76 | 18.07 | 17.58 | 16.83 |
| MgO + CaO + SrO + BaO | 2.55 | 6.31 | 6.39 | 6.50 | 6.54 | 6.57 |
| BaO/(MgO + CaO + SrO + BaO) | 0.00 | 0.00 | 0.00 | 0.00 | 0.00 | 0.00 |
| TiO₂ + Nb₂O₅ | 32.71 | 31.60 | 31.97 | 32.55 | 32.75 | 32.90 |
| TiO₂/CaO | 9.114 | 3.551 | 3.551 | 3.551 | 3.551 | 3.551 |
| TiO₂/(TiO₂ + Nb₂O₅) | 0.710 | 0.710 | 0.710 | 0.710 | 0.710 | 0.710 |
| SiO₂/(SiO₂ + B₂O₃) | 0.42 | 0.49 | 0.35 | 0.47 | 0.40 | 0.42 |
| Li₂O + Na₂O + K₂O | 1.06 | 0.00 | 0.00 | 0.00 | 0.00 | 0.36 |
| MgO + CaO + SrO + BaO + ZnO | 3.89 | 7.61 | 7.70 | 7.84 | 7.89 | 7.92 |
| CaO/(MgO + CaO + SrO + BaO) | 1.00 | 1.00 | 1.00 | 1.00 | 1.00 | 1.00 |
| Y₂O₃ + La₂O₃ + Gd₂O₃ | 38.13 | 36.83 | 37.26 | 34.10 | 34.30 | 34.47 |
| Y₂O₃/(Y₂O₃ + La₂O₃ + Gd₂O₃) | 0.00 | 0.00 | 0.00 | 0.00 | 0.00 | 0.00 |
| (TiO₂ + Nb₂O₅)/(Y₂O₃ + La₂O₃ + Gd₂O₃) | 0.86 | 0.86 | 0.86 | 0.95 | 0.95 | 0.95 |
| nd | 2.01536 | 2.00225 | 2.01169 | 1.99551 | 2.00015 | 2.00468 |
| vd | 24.62 | 25.26 | 25.05 | 25.01 | 24.90 | 24.89 |
| Specific gravity (g/cc) | 4.46 | 4.44 | 4.46 | 4.35 | 4.36 | 4.38 |

TABLE 4

| No. | 19 | 20 | 21 | 22 | 23 | 24 |
|---|---|---|---|---|---|---|
| SiO₂ | 7.00 | 6.89 | 7.08 | 7.18 | 7.22 | 7.04 |
| B₂O₃ | 9.67 | 9.53 | 9.79 | 9.92 | 10.27 | 10.01 |
| Li₂O | 0.00 | 0.00 | 0.00 | 0.00 | 0.00 | 0.00 |
| Na₂O | 0.00 | 0.00 | 0.00 | 0.00 | 0.00 | 0.00 |
| K₂O | 0.00 | 0.00 | 0.00 | 0.00 | 0.00 | 0.00 |
| MgO | 0.00 | 0.00 | 0.00 | 0.00 | 0.00 | 0.00 |
| CaO | 7.83 | 6.41 | 7.93 | 8.04 | 8.09 | 6.55 |
| SrO | 0.00 | 0.00 | 0.00 | 0.00 | 0.00 | 0.00 |
| BaO | 0.00 | 0.00 | 0.00 | 0.00 | 0.00 | 0.00 |
| ZnO | 1.34 | 1.32 | 1.35 | 1.37 | 1.38 | 1.34 |
| TiO₂ | 23.12 | 24.64 | 25.32 | 27.58 | 28.12 | 27.40 |
| Nb₂O₅ | 9.46 | 9.32 | 6.41 | 3.27 | 0.00 | 0.00 |
| WO₃ | 0.00 | 0.00 | 0.00 | 0.00 | 0.00 | 0.00 |
| ZrO₂ | 7.45 | 4.47 | 7.55 | 7.64 | 7.69 | 7.50 |
| Y₂O₃ | 0.00 | 0.00 | 0.00 | 0.00 | 0.00 | 0.00 |
| La₂O₃ | 34.13 | 37.42 | 34.56 | 35.01 | 37.23 | 40.15 |
| Gd₂O₃ | 0.00 | 0.00 | 0.00 | 0.00 | 0.00 | 0.00 |
| Yb₂O₃ | 0.00 | 0.00 | 0.00 | 0.00 | 0.00 | 0.00 |
| Ta₂O₅ | 0.00 | 0.00 | 0.00 | 0.00 | 0.00 | 0.00 |
| Sb₂O₃ | 0.01 | 0.01 | 0.01 | 0.01 | 0.01 | 0.01 |
| Total | 100.01 | 100.01 | 100.01 | 100.01 | 100.01 | 100.01 |
| SiO₂ + B₂O₃ | 16.67 | 16.42 | 16.88 | 17.09 | 17.49 | 17.05 |
| MgO + CaO + SrO + BaO | 7.83 | 6.41 | 7.93 | 8.04 | 8.09 | 6.55 |
| BaO/(MgO + CaO + SrO + BaO) | 0.00 | 0.00 | 0.00 | 0.00 | 0.00 | 0.00 |
| TiO₂ + Nb₂O₅ | 32.58 | 33.96 | 31.73 | 30.85 | 28.12 | 27.40 |
| TiO₂/CaO | 2.951 | 3.841 | 3.19 | 3.43 | 3.48 | 4.18 |
| TiO₂/(TiO₂ + Nb₂O₅) | 0.710 | 0.725 | 0.80 | 0.89 | 1.00 | 1.00 |
| SiO₂/(SiO₂ + B₂O₃) | 0.42 | 0.42 | 0.42 | 0.42 | 0.41 | 0.41 |
| Li₂O + Na₂O + K₂O | 0.00 | 0.00 | 0.00 | 0.00 | 0.00 | 0.00 |
| MgO + CaO + SrO + BaO + ZnO | 9.17 | 7.73 | 9.29 | 9.4 | 9.47 | 7.90 |
| CaO/(MgO + CaO + SrO + BaO) | 1.00 | 1.00 | 1.00 | 1.00 | 1.00 | 1.00 |
| Y₂O₃ + La₂O₃ + Gd₂O₃ | 34.13 | 37.42 | 34.56 | 35.01 | 37.23 | 40.15 |
| Y₂O₃/(Y₂O₃ + La₂O₃ + Gd₂O₃) | 0.00 | 0.00 | 0.00 | 0.00 | 0.00 | 0.00 |
| (TiO₂ + Nb₂O₅)/(Y₂O₃ + La₂O₃ + Gd₂O₃) | 0.95 | 0.91 | 0.92 | 0.88 | 0.76 | 0.68 |
| nd | 2.00100 | 2.01254 | 2.00177 | 2.00255 | 1.99376 | 2.00019 |
| vd | 25.07 | 24.46 | 24.86 | 24.69 | 25.22 | 25.30 |
| Specific gravity (g/cc) | 4.37 | 4.41 | 4.34 | 4.32 | 4.33 | 4.41 |

TABLE 5

| No. | 25 | 26 | 27 | 28 | 29 | 30 |
|---|---|---|---|---|---|---|
| SiO₂ | 7.19 | 7.22 | 7.27 | 7.02 | 8.39 | 5.63 |
| B₂O₃ | 9.37 | 9.98 | 10.05 | 9.70 | 8.82 | 10.59 |
| Li₂O | 0.00 | 0.00 | 0.00 | 0.00 | 0.00 | 0.00 |
| Na₂O | 0.00 | 0.00 | 0.00 | 0.00 | 0.00 | 0.00 |
| K₂O | 0.00 | 0.00 | 0.00 | 0.00 | 0.00 | 0.00 |
| MgO | 0.00 | 0.00 | 0.00 | 0.00 | 0.00 | 0.00 |
| CaO | 9.41 | 8.09 | 8.14 | 5.87 | 5.83 | 5.90 |
| SrO | 0.00 | 0.00 | 0.00 | 0.00 | 0.00 | 0.00 |
| BaO | 0.00 | 0.00 | 0.00 | 5.45 | 5.42 | 5.48 |
| ZnO | 1.37 | 1.38 | 1.39 | 1.34 | 1.33 | 1.35 |
| TiO₂ | 27.97 | 28.73 | 29.94 | 28.90 | 28.73 | 29.08 |
| Nb₂O₅ | 0.00 | 1.67 | 0.00 | 0.00 | 0.00 | 0.00 |
| WO₃ | 0.00 | 0.00 | 0.00 | 0.00 | 0.00 | 0.00 |
| ZrO₂ | 7.65 | 7.69 | 7.74 | 7.48 | 7.43 | 7.52 |
| Y₂O₃ | 0.00 | 0.00 | 0.00 | 0.00 | 0.00 | 0.00 |
| La₂O₃ | 37.04 | 35.23 | 35.47 | 34.24 | 34.04 | 34.45 |
| Gd₂O₃ | 0.00 | 0.00 | 0.00 | 0.00 | 0.00 | 0.00 |
| Yb₂O₃ | 0.00 | 0.00 | 0.00 | 0.00 | 0.00 | 0.00 |
| Ta₂O₅ | 0.00 | 0.00 | 0.00 | 0.00 | 0.00 | 0.00 |
| Sb₂O₃ | 0.01 | 0.01 | 0.01 | 0.01 | 0.01 | 0.01 |
| Total | 100.01 | 100.01 | 100.01 | 100.01 | 100.01 | 100.01 |
| SiO₂ + B₂O₃ | 16.56 | 17.20 | 17.32 | 16.72 | 17.22 | 16.22 |
| MgO + CaO + SrO + BaO | 9.41 | 8.09 | 8.14 | 11.32 | 11.25 | 11.39 |
| BaO/(MgO + CaO + SrO + BaO) | 0.00 | 0.00 | 0.00 | 0.48 | 0.48 | 0.48 |
| TiO₂ + Nb₂O₅ | 27.97 | 30.40 | 29.94 | 28.90 | 28.73 | 29.08 |
| TiO₂/CaO | 2.97 | 3.55 | 3.68 | 4.93 | 4.93 | 4.93 |
| TiO₂/(TiO₂ + Nb₂O₅) | 1.00 | 0.95 | 1.00 | 1.00 | 1.00 | 1.00 |
| SiO₂/(SiO₂ + B₂O₃) | 0.43 | 0.42 | 0.42 | 0.42 | 0.49 | 0.35 |
| Li₂O + Na₂O + K₂O | 0.00 | 0.00 | 0.00 | 0.00 | 0.00 | 0.00 |
| MgO + CaO + SrO + BaO + ZnO | 10.78 | 9.47 | 9.53 | 12.66 | 12.58 | 12.73 |
| CaO/(MgO + CaO + SrO + BaO) | 1.00 | 1.00 | 1.00 | 0.52 | 0.52 | 0.52 |
| Y₂O₃ + La₂O₃ + Gd₂O₃ | 37.04 | 35.23 | 35.47 | 34.24 | 34.04 | 34.45 |
| Y₂O₃/(Y₂O₃ + La₂O₃ + Gd₂O₃) | 0.00 | 0.00 | 0.00 | 0.00 | 0.00 | 0.00 |
| (TiO₂ + Nb₂O₅)/(Y₂O₃ + La₂O₃ + Gd₂O₃) | 0.76 | 0.86 | 0.84 | 0.84 | 0.84 | 0.84 |
| nd | 1.99340 | 2.00331 | 2.00371 | 2.00052 | 1.99559 | 2.00449 |
| vd | 25.39 | 24.60 | 24.51 | 24.63 | 24.74 | 24.54 |
| Specific gravity (g/cc) | 4.33 | 4.30 | 4.29 | 4.38 | 4.37 | 4.39 |

TABLE 6

| No. | 31 | 32 | 33 | 34 | 35 | 36 |
|---|---|---|---|---|---|---|
| SiO₂ | 7.26 | 7.35 | 7.45 | 7.54 | 7.04 | 7.16 |
| B₂O₃ | 10.04 | 10.16 | 10.29 | 10.42 | 9.73 | 9.89 |
| Li₂O | 0.00 | 0.00 | 0.00 | 0.00 | 0.00 | 0.00 |
| Na₂O | 0.00 | 0.00 | 0.00 | 0.00 | 0.00 | 0.00 |
| K₂O | 0.00 | 0.00 | 0.00 | 0.00 | 0.00 | 0.00 |
| MgO | 0.00 | 0.00 | 0.00 | 0.00 | 0.00 | 0.00 |
| CaO | 8.13 | 8.24 | 8.34 | 8.45 | 6.55 | 5.98 |
| SrO | 0.00 | 0.00 | 0.00 | 0.00 | 0.00 | 0.00 |
| BaO | 0.00 | 0.00 | 0.00 | 0.00 | 5.47 | 5.56 |
| ZnO | 1.39 | 1.40 | 1.42 | 1.44 | 0.38 | 3.33 |
| TiO₂ | 27.92 | 28.27 | 28.62 | 28.99 | 28.99 | 29.47 |
| Nb₂O₅ | 3.31 | 3.35 | 3.39 | 3.43 | 0.00 | 0.00 |
| WO₃ | 0.00 | 0.00 | 0.00 | 0.00 | 0.00 | 0.00 |
| ZrO₂ | 7.74 | 7.83 | 7.93 | 8.03 | 7.50 | 7.62 |
| Y₂O₃ | 2.77 | 5.61 | 8.52 | 11.50 | 0.00 | 0.00 |
| La₂O₃ | 31.44 | 27.79 | 24.04 | 20.20 | 34.35 | 30.98 |
| Gd₂O₃ | 0.00 | 0.00 | 0.00 | 0.00 | 0.00 | 0.00 |
| Yb₂O₃ | 0.00 | 0.00 | 0.00 | 0.00 | 0.00 | 0.00 |
| Ta₂O₅ | 0.00 | 0.00 | 0.00 | 0.00 | 0.00 | 0.00 |
| Sb₂O₃ | 0.01 | 0.01 | 0.01 | 0.01 | 0.01 | 0.01 |
| Total | 100.01 | 100.01 | 100.01 | 100.01 | 100.01 | 100.01 |
| SiO₂ + B₂O₃ | 17.30 | 17.52 | 17.74 | 17.96 | 16.77 | 17.05 |
| MgO + CaO + SrO + BaO | 8.13 | 8.24 | 8.34 | 8.45 | 12.02 | 11.54 |
| BaO/(MgO + CaO + SrO + BaO) | 0.00 | 0.00 | 0.00 | 0.00 | 0.45 | 0.48 |
| TiO₂ + Nb₂O₅ | 31.23 | 31.62 | 32.01 | 32.42 | 28.99 | 29.47 |
| TiO₂/CaO | 3.43 | 3.43 | 3.43 | 3.43 | 4.42 | 4.93 |
| TiO₂/(TiO₂ + Nb₂O₅) | 0.89 | 0.89 | 0.89 | 0.89 | 1.00 | 1.00 |
| SiO₂/(SiO₂ + B₂O₃) | 0.42 | 0.42 | 0.42 | 0.42 | 0.42 | 0.42 |
| Li₂O + Na₂O + K₂O | 0.00 | 0.00 | 0.00 | 0.00 | 0.00 | 0.00 |
| MgO + CaO + SrO + BaO + ZnO | 9.52 | 9.64 | 9.76 | 9.89 | 12.40 | 14.87 |
| CaO/(MgO + CaO + SrO + BaO) | 1.00 | 1.00 | 1.00 | 1.00 | 0.55 | 0.52 |
| Y₂O₃ + La₂O₃ + Gd₂O₃ | 34.21 | 33.39 | 32.56 | 31.70 | 34.35 | 30.98 |
| Y₂O₃/(Y₂O₃ + La₂O₃ + Gd₂O₃) | 0.08 | 0.17 | 0.26 | 0.36 | 0.00 | 0.00 |
| (TiO₂ + Nb₂O₅)/(Y₂O₃ + La₂O₃ + Gd₂O₃) | 0.91 | 0.95 | 0.98 | 1.02 | 0.84 | 0.95 |
| nd | 2.00065 | 1.99839 | 1.99608 | 1.99360 | 1.99828 | 1.99932 |
| vd | 24.65 | 24.64 | 24.61 | 24.59 | 24.73 | 24.35 |
| Specific gravity (g/cc) | 4.28 | 4.24 | 4.20 | 4.16 | 4.36 | 4.34 |

TABLE 7

| No. | 37 | 38 | 39 | 40 | 41 |
|---|---|---|---|---|---|
| SiO₂ | 7.32 | 7.40 | 7.08 | 8.24 | 7.25 |
| B₂O₃ | 10.12 | 10.22 | 9.79 | 9.98 | 10.61 |
| Li₂O | 0.00 | 0.00 | 0.00 | 0.00 | 0.00 |
| Na₂O | 0.00 | 0.00 | 0.00 | 0.00 | 0.00 |
| K₂O | 0.00 | 0.00 | 0.00 | 0.00 | 0.00 |
| MgO | 0.00 | 0.00 | 0.00 | 0.00 | 0.00 |
| CaO | 8.20 | 8.28 | 6.59 | 8.09 | 8.12 |
| SrO | 0.00 | 0.00 | 0.00 | 0.00 | 0.00 |
| BaO | 0.00 | 0.00 | 0.00 | 0.00 | 0.00 |
| ZnO | 1.40 | 4.46 | 1.35 | 0.00 | 0.00 |
| TiO₂ | 30.12 | 28.42 | 29.17 | 28.24 | 28.36 |
| Nb₂O₅ | 3.34 | 3.37 | 0.00 | 3.29 | 3.30 |
| WO₃ | 0.00 | 0.00 | 0.00 | 0.00 | 0.00 |
| ZrO₂ | 7.80 | 7.87 | 7.55 | 6.94 | 6.97 |
| Y₂O₃ | 0.00 | 0.00 | 0.00 | 0.00 | 0.00 |
| La₂O₃ | 31.70 | 29.98 | 38.47 | 35.22 | 35.39 |
| Gd₂O₃ | 0.00 | 0.00 | 0.00 | 0.00 | 0.00 |
| Yb₂O₃ | 0.00 | 0.00 | 0.00 | 0.00 | 0.00 |
| Ta₂O₅ | 0.00 | 0.00 | 0.00 | 0.00 | 0.00 |
| Sb₂O₃ | 0.01 | 0.01 | 0.01 | 0.01 | 0.01 |
| Total | 100.01 | 100.01 | 100.01 | 100.01 | 100.01 |
| SiO₂ + B₂O₃ | 17.44 | 17.62 | 16.87 | 18.22 | 17.86 |
| MgO + CaO + SrO + BaO | 8.20 | 8.28 | 6.59 | 8.09 | 8.12 |
| BaO/(MgO + CaO + SrO + BaO) | 0.00 | 0.00 | 0.00 | 0.00 | 0.00 |
| TiO₂ + Nb₂O₅ | 33.46 | 31.79 | 29.17 | 31.53 | 31.66 |
| TiO₂/CaO | 3.67 | 3.43 | 4.43 | 3.49 | 3.49 |
| TiO₂/(TiO₂ + Nb₂O₅) | 0.90 | 0.89 | 1.00 | 0.90 | 0.90 |
| SiO₂/(SiO₂ + B₂O₃) | 0.42 | 0.42 | 0.42 | 0.45 | 0.41 |
| Li₂O + Na₂O + K₂O | 0.00 | 0.00 | 0.00 | 0.00 | 0.00 |
| MgO + CaO + SrO + BaO + ZnO | 9.60 | 12.74 | 7.94 | 8.09 | 8.12 |
| CaO/(MgO + CaO + SrO + BaO) | 1.00 | 1.00 | 1.00 | 1.00 | 1.00 |
| Y₂O₃ + La₂O₃ + Gd₂O₃ | 31.70 | 29.98 | 38.47 | 35.22 | 35.39 |
| Y₂O₃/(Y₂O₃ + La₂O₃ + Gd₂O₃) | 0.00 | 0.00 | 0.00 | 0.00 | 0.00 |
| (TiO₂ + Nb₂O₅)/(Y₂O₃ + La₂O₃ + Gd₂O₃) | 1.06 | 1.06 | 0.76 | 0.90 | 0.89 |
| nd | 2.01241 | 2.00239 | 2.01021 | 1.99725 | 2.00057 |
| vd | 23.75 | 24.54 | 24.58 | 24.60 | 24.49 |
| Specific gravity (g/cc) | 4.24 | 4.25 | 4.38 | 4.26 | 4.27 |

TABLE 8

| No. | 42 | 43 | 44 | 45 | 46 |
|---|---|---|---|---|---|
| SiO₂ | 7.23 | 7.16 | 9.84 | 4.26 | 11.19 |
| B₂O₃ | 9.99 | 9.89 | 8.03 | 11.60 | 7.16 |
| Li₂O | 0.00 | 0.00 | 0.00 | 0.00 | 0.00 |
| Na₂O | 0.00 | 0.00 | 0.00 | 0.00 | 0.00 |
| K₂O | 0.00 | 0.00 | 0.00 | 0.00 | 0.00 |
| MgO | 0.00 | 0.00 | 0.00 | 0.00 | 0.00 |
| CaO | 9.04 | 8.01 | 6.51 | 6.67 | 6.48 |
| SrO | 0.00 | 0.00 | 0.00 | 0.00 | 0.00 |
| BaO | 0.00 | 0.00 | 0.00 | 0.00 | 0.00 |
| ZnO | 0.00 | 0.00 | 1.34 | 1.37 | 1.33 |
| TiO₂ | 28.26 | 27.99 | 28.82 | 29.53 | 28.65 |
| Nb₂O₅ | 3.29 | 3.26 | 0.00 | 0.00 | 0.00 |
| WO₃ | 0.00 | 0.00 | 0.00 | 0.00 | 0.00 |
| ZrO₂ | 6.94 | 6.88 | 7.46 | 7.64 | 7.41 |
| Y₂O₃ | 0.00 | 1.90 | 0.00 | 0.00 | 0.00 |
| La₂O₃ | 35.25 | 34.91 | 38.00 | 38.93 | 37.78 |
| Gd₂O₃ | 0.00 | 0.00 | 0.00 | 0.00 | 0.00 |
| Yb₂O₃ | 0.00 | 0.00 | 0.00 | 0.00 | 0.00 |
| Ta₂O₅ | 0.00 | 0.00 | 0.00 | 0.00 | 0.00 |
| Sb₂O₃ | 0.01 | 0.01 | 0.01 | 0.01 | 0.01 |
| Total | 100.01 | 100.01 | 100.01 | 100.01 | 100.01 |
| SiO₂ + B₂O₃ | 17.22 | 17.05 | 17.87 | 15.86 | 18.35 |
| MgO + CaO + SrO + BaO | 9.04 | 8.01 | 6.51 | 6.67 | 6.48 |
| BaO/(MgO + CaO + SrO + BaO) | 0.00 | 0.00 | 0.00 | 0.00 | 0.00 |
| TiO₂ + Nb₂O₅ | 31.55 | 31.25 | 28.82 | 29.53 | 28.65 |
| TiO₂/CaO | 3.13 | 3.49 | 4.43 | 4.43 | 4.42 |
| TiO₂/(TiO₂ + Nb₂O₅) | 0.90 | 0.90 | 1.00 | 1.00 | 1.00 |
| SiO₂/(SiO₂ + B₂O₃) | 0.42 | 0.42 | 0.55 | 0.27 | 0.61 |
| Li₂O + Na₂O + K₂O | 0.00 | 0.00 | 0.00 | 0.00 | 0.00 |
| MgO + CaO + SrO + BaO + ZnO | 9.04 | 8.01 | 7.85 | 8.04 | 7.81 |
| CaO/(MgO + CaO + SrO + BaO) | 1.00 | 1.00 | 1.00 | 1.00 | 1.00 |
| Y₂O₃ + La₂O₃ + Gd₂O₃ | 35.25 | 36.81 | 38.00 | 38.93 | 37.78 |
| Y₂O₃/(Y₂O₃ + La₂O₃ + Gd₂O₃) | 0.00 | 0.05 | 0.00 | 0.00 | 0.00 |
| (TiO₂ + Nb₂O₅)/(Y₂O₃ + La₂O₃ + Gd₂O₃) | 0.90 | 0.85 | 0.76 | 0.76 | 0.76 |
| nd | 2.00088 | 2.00376 | 2.00085 | 2.02010 | 1.99616 |
| vd | 24.65 | 24.68 | 24.80 | 24.36 | 24.94 |
| Specific gravity (g/cc) | 4.28 | 4.31 | 4.35 | 4.41 | 4.33 |

TABLE 9

| No. | 47 | 48 | 49 | 50 | 51 |
|---|---|---|---|---|---|
| SiO₂ | 1.37 | 6.79 | 6.93 | 7.45 | 8.19 |
| B₂O₃ | 13.45 | 9.38 | 9.58 | 9.34 | 9.30 |
| Li₂O | 0.00 | 0.00 | 0.00 | 0.00 | 0.00 |
| Na₂O | 0.00 | 0.00 | 0.00 | 0.00 | 0.00 |
| K₂O | 0.00 | 0.00 | 0.00 | 0.00 | 0.00 |
| MgO | 0.00 | 0.00 | 0.00 | 0.00 | 0.00 |
| CaO | 6.76 | 3.86 | 5.14 | 3.45 | 4.83 |
| SrO | 0.00 | 0.00 | 0.00 | 0.00 | 0.00 |
| BaO | 0.00 | 3.22 | 0.00 | 3.20 | 0.00 |
| ZnO | 1.39 | 1.30 | 1.32 | 0.00 | 0.00 |
| TiO₂ | 29.89 | 27.14 | 27.71 | 26.58 | 27.15 |
| Nb₂O₅ | 0.00 | 0.00 | 0.00 | 0.00 | 0.00 |
| WO₃ | 0.00 | 0.00 | 0.00 | 0.00 | 0.00 |
| ZrO₂ | 7.73 | 7.23 | 7.38 | 6.50 | 6.63 |
| Y₂O₃ | 0.00 | 2.59 | 2.64 | 5.15 | 4.74 |
| La₂O₃ | 39.41 | 38.49 | 39.30 | 38.33 | 39.16 |
| Gd₂O₃ | 0.00 | 0.00 | 0.00 | 0.00 | 0.00 |
| Yb₂O₃ | 0.00 | 0.00 | 0.00 | 0.00 | 0.00 |
| Ta₂O₅ | 0.00 | 0.00 | 0.00 | 0.00 | 0.00 |
| Sb₂O₃ | 0.0 | 0.01 | 0.01 | 0.0 | 0.01 |
| Total | 100.01 | 100.01 | 100.01 | 100.01 | 100.01 |
| SiO₂ + B₂O₃ | 14.82 | 16.17 | 16.51 | 16.79 | 17.49 |
| MgO + CaO + SrO + BaO | 6.76 | 7.08 | 5.14 | 6.65 | 4.83 |
| BaO/(MgO + CaO + SrO + BaO) | 0.00 | 0.45 | 0.00 | 0.48 | 0.00 |
| TiO₂ + Nb₂O₅ | 29.89 | 27.14 | 27.71 | 26.58 | 27.15 |
| TiO₂/CaO | 4.42 | 7.03 | 5.39 | 7.70 | 5.62 |
| TiO₂/(TiO₂ + Nb₂O₅) | 1.00 | 1.00 | 1.00 | 1.00 | 1.00 |
| SiO₂/(SiO₂ + B₂O₃) | 0.09 | 0.42 | 0.42 | 0.44 | 0.47 |
| Li₂O + Na₂O + K₂O | 0.00 | 0.00 | 0.00 | 0.00 | 0.00 |
| MgO + CaO + SrO + BaO + ZnO | 8.15 | 8.38 | 6.46 | 6.65 | 4.83 |
| CaO/(MgO + CaO + SrO + BaO) | 1.00 | 0.55 | 1.00 | 0.52 | 1.00 |
| Y₂O₃ + La₂O₃ + Gd₂O₃ | 39.41 | 41.08 | 41.94 | 43.48 | 43.90 |
| Y₂O₃/(Y₂O₃ + La₂O₃ + Gd₂O₃) | 0.00 | 0.06 | 0.06 | 0.12 | 0.11 |
| (TiO₂ + Nb₂O₅)/(Y₂O₃ + La₂O₃ + Gd₂O₃) | 0.76 | 0.66 | 0.66 | 0.61 | 0.62 |
| nd | 2.02932 | 2.00855 | 2.01043 | 2.00072 | 2.00045 |
| vd | 24.16 | 25.13 | 25.06 | 25.55 | 25.49 |
| Specific gravity (g/cc) | 4.43 | 4.51 | 4.46 | 4.50 | 4.43 |

### Example 2

Each optical glass obtained in Example 1 was used to prepare a glass block (glass gob) for press molding. This glass block was heated and softened in the air, and press molded in a press mold to prepare a lens blank (optical element blank). The lens blanks thus prepared were removed from the press mold, annealed, and machined, including polishing, to prepare spherical lenses each comprised of the respective optical glass of Example 1.

### Example 3

A desired amount of each molten glass prepared in Example 1 was press molded in a press mold to prepare a lens blank (optical element blank). The lens blanks thus prepared were removed from the press mold, annealed, and machined, including polishing, to prepare spherical lenses each comprised of the respective optical glass of Example 1.

### Example 4

Glass blocks (optical element blanks) prepared by solidifying the molten glasses prepared in Example 1 were annealed and machined, including polishing, to prepare spherical lenses each comprised of the respective optical glass of Example 1.

### Example 5

The spherical lenses prepared in Examples 2 to 4 were bonded to spherical lenses comprised of other types of glass to prepare cemented lenses.

### Example 6

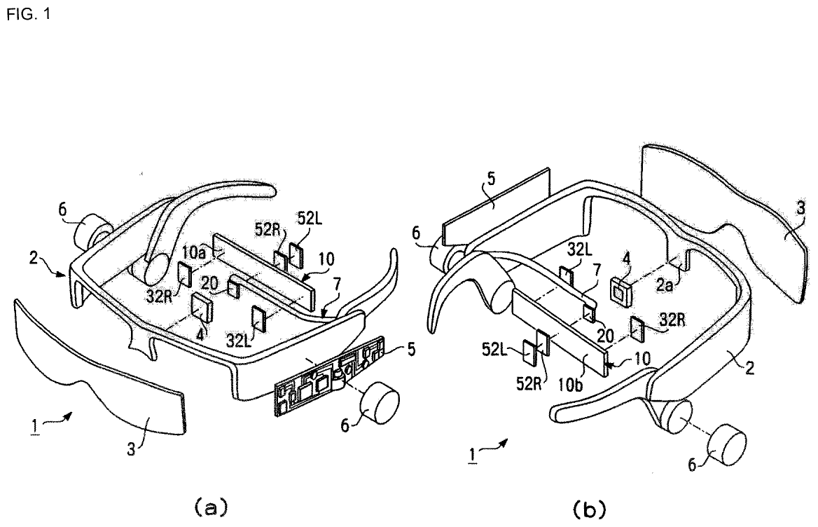

FIG. 1 shows schematic configuration diagrams of a head mounted display, which is an example of an image device including an image display element and a light guide plate. A head mounted display 1 having the configuration shown in FIG. 1 was prepared by the following method.

Each of the optical glasses in Example 1 was processed into a rectangular thin plate measuring 50 mm long×20 mm wide×1.0 mm thick to obtain respective light guide plates 10.

The light guide plate was attached to the head mounted display 1 (hereinafter abbreviated as “HMD 1”) shown in FIG. 1. FIG. 1(a) is a front perspective view of the HMD 1, and FIG. 1(b) is a rear perspective view of the HMD 1. As shown in FIG. 1(a) and FIG. 1(b), a spectacle lens 3 is attached to the front part of a spectacle-type frame 2 worn on the head of a user. A backlight 4 for illuminating an image is attached to a mounting part 2a of the spectacle-type frame 2. A signal processing device 5 for projecting an image and a speaker 6 for reproducing sound are provided on the temple part of the spectacle-type frame 2. A FPC (flexible printed circuit) 7 constituting wiring drawn from the circuit of the signal processing device 5 is wired along the spectacle-type frame 2. A display element unit (for example, a liquid crystal display element) 20 is wired by the FPC 7 to the center position between the eyes of the user and is held so that the approximate center of the display element unit 20 is located on the optical axis of the backlight 4. The display element unit 20 is fixed relative to the light guide plate 10 so as to be located approximately at the center of the light guide plate 10. In addition, HOEs (Holographic Optical Elements) 32R and 32L (first optical elements) are fixed in close contact with the first surface 10a of the light guide plate 10 by adhesive or the like at the positions in front of the user's eyes. HOEs 52R and 52L are stacked on a second surface 10b of the light guide plate 10 at positions facing the display element unit 20 across the light guide plate 10.

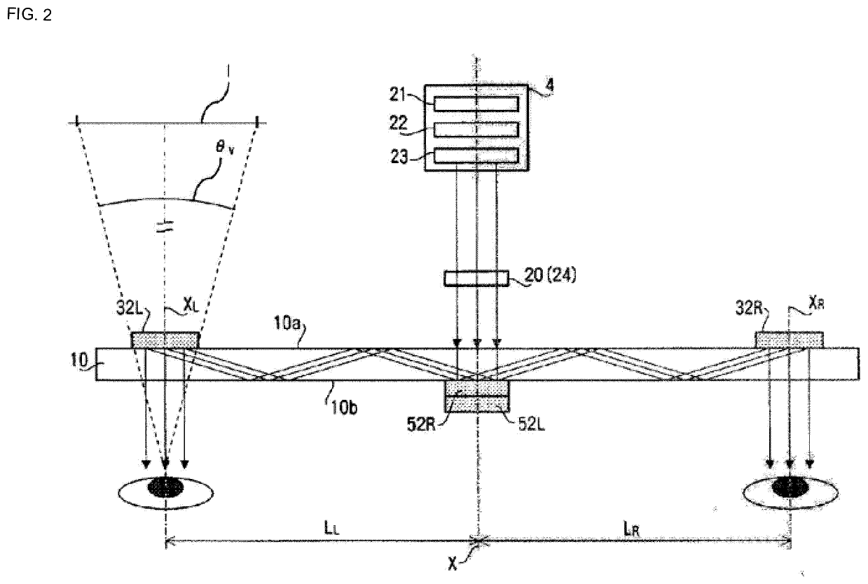

FIG. 2 shows a side view showing a schematic configuration of the HMD 1 shown in FIG. 1. In FIG. 2, only the main parts are shown for clarity of the drawing, and the spectacle-type frame 2 and the like are omitted. As shown in FIG. 2, the HMD 1 has a structure symmetrical with respect to a center line X connecting the image display element 24 and the center of the light guide plate 10. In addition, the light of each wavelength incident on the light guide plate 10 from the image display element 24 is divided into two which are guided to the right eye and the left eye of the user, respectively, as described below. The optical paths of the light of each wavelength guided to each eye are also approximately symmetrical with respect to the center line X.

As shown in FIG. 2, the backlight 4 has a laser light source 21, a diffusion optical system 22, and a microlens array 23. The display element unit 20 is an image generating unit having an image display element 24, and is driven, for example, by a field sequential method. The laser light source 21 has laser light sources corresponding to the wavelengths of B (wavelength 436 nm), G (wavelength 546 nm), and R (wavelength 633 nm), and sequentially radiates light of each wavelength at high speed. The light of each wavelength is incident on the diffusion optical system 22 and the microlens array 23, and is converted into a uniform, highly directional parallel light beam without unevenness in the quantity of light and is perpendicularly incident on the display panel surface of the image display element 24.

The image display element 24 is, for example, a transmissive liquid crystal (LCDT-LCOS) panel driven by a field sequential method. The image display element 24 modulates the light of each wavelength according to the image signal generated by an image engine (not shown) of the signal processing device 5. The light of each wavelength modulated by the pixels in the effective area of the image display element 24 is incident on the light guide plate 10 with a predetermined light beam cross section (approximately the same shape as the effective area). The image display element 24 can also be replaced with other types of display elements, such as a DMD (Digital Mirror Device), a reflective liquid crystal (LCOS) panel, MEMS (Micro Electro Mechanical Systems), organic EL (Electro-Luminescence), inorganic EL, and the like.

The display element unit 20 is not limited to a field sequential type display element, but may be also configured as an image generating unit of a simultaneous type display element (a display element having a predetermined arrangement of RGB color filters in front of the emission surface). In this case, for example, a white light source is used as the light source.

As shown in FIG. 2, the light of each wavelength modulated by the image display element 24 is sequentially incident on the inside of the light guide plate 10 from the first surface 10a. HOEs 52R and 52L (second optical elements) are stacked on the second surface 10b of the light guide plate 10. The HOEs 52R and 52L are, for example, reflective volume phase type HOEs having a rectangular shape, and are configured by laminating three photopolymers on which interference fringes corresponding to the light of each wavelength of R, G, and B are recorded. That is, the HOEs 52R and 52L are configured to have a wavelength selection function of diffracting the light of each wavelength of R, G, and B and transmitting the light of the other wavelengths.

HOEs 32R and 32L are also reflective volume phase type HOEs and have the same layer structure as the HOEs 52R and 52L. For example, the pitch of the interference fringe pattern of HOEs 32R and 32L and HOEs 52R and 52L may be approximately the same.

The HOEs 52R and 52L are stacked with the centers thereof aligned and with interference fringe patterns thereof inverted by 180 degrees. In the stacked state, the HOEs are brought in close contact and fixed to the second surface 10b of the light guide plate 10 with an adhesive or the like so that the centers thereof are aligned with the center line X. Light of each wavelength modulated by the image display element 24 is sequentially incident on the HOEs 52R and 52L through the light guide plate 10.

The HOEs 52R and 52L diffract the sequentially incident light of each wavelength at a predetermined angle to guide the light to the right eye and left eye, respectively. The light of each wavelength diffracted by the HOEs 52R and 52L undergoes repeated total reflection at the interface between the light guide plate 10 and the air, propagates inside the light guide plate 10, and is incident on the HOEs 32R and 32L. Here, the HOEs 52R and 52L give the same diffraction angle to the light of each wavelength. Therefore, the light of all wavelengths incident on the light guide plate 10 at approximately the same position (or, rephrasing, emitted from approximately the same coordinates within the effective area of the image display element 24) propagates through approximately the same optical path inside the light guide plate 10 and is incident on approximately the same position on the HOEs 32R and 32L. From another viewpoint, the HOEs 52R and 52L diffract the light of each wavelength of RGB so that the pixel positional relationship within the effective area of the image displayed in the effective area of the image display element 24 is faithfully reproduced on the HOEs 32R and 32L.

Thus, in the present example, the HOEs 52R and 52L diffract the light of all wavelengths emitted from approximately the same coordinates within the effective area of the image display element 24 so that the light is incident on approximately the same position on the HOEs 32R and 32L. Alternatively, the HOEs 52R and 52L may be configured to diffract the light of all wavelengths that originally constitute the same pixels, which are shifted relative to each other within the effective area of the image display element 24, so that the light is incident on approximately the same position on the HOEs 32R and 32L.

The light of each wavelength incident on the HOEs 32R and 32L is diffracted by the HOEs 32R and 32L and is sequentially emitted approximately perpendicularly to the outside from the second surface 10b of the light guide plate 10. The light of each wavelength emitted as approximately parallel light in this manner forms a virtual image I of the image generated by the image display element 24 on the right and left retinas of the user. In addition, the HOEs 32R and 32L may be provided with a condenser function so that the user could observe the virtual image I of the enlarged image. That is, the light incident on the peripheral regions of the HOEs 32R and 32L may be emitted at an angle closer to the center of the pupil and to form an image on the retina of the user. Alternatively, in order to allow the user to view a virtual image I of an enlarged image, the HOEs 52R and 52L may diffract light of each wavelength of RGB so that the pixel positional relationship on the HOEs 32R and 32L forms an enlarged similar shape with respect to the pixel positional relationship in the effective region of the image displayed on the effective region of the image display element 24.

The air-converted optical path length of light traveling through the light guide plate 10 becomes shorter as the refractive index increases, so by using the optical glasses with a high refractive index, the apparent viewing angle relative to the width of the image display element 24 can be increased. Furthermore, since the specific gravity of the glass with a high refractive index is kept low, it is possible to provide a light guide plate that is lightweight yet makes it possible to obtain the above effects.

When the light guide plate 10 obtained in this manner was incorporated into the HMD 1 and the image was evaluated at the eyepoint position, a high-brightness, high-contrast image could be observed at a wide viewing angle.

The light guide plate comprised of each of the above optical glasses can be used in see-through transmissive head mounted displays and non-transmissive head mounted displays.

As a result of having a light guide plate comprised of glass with a high refractive index, these head mounted displays realize excellent sense of immersion due to a wide viewing angle and are suitable as image display devices to be used in combination with information terminals, for providing AR (Augmented Reality), watching movies, playing games, providing VR (Virtual Reality), and the like.

In the present example, a head mounted display has been used as an example, but the light guide plate may also be attached to other image display devices.

It should be considered that the embodiments disclosed this time are illustrative, and are not restrictive in terms of all the points. It is intended that the scope of the present disclosure is shown not by the explanations but by the appended claims, and includes all the changes within the meaning and scope equivalent to the appended claims.

For example, by performing the adjustment of the composition described in the specification on the exemplified glass composition, it is possible to obtain optical glass in accordance with one aspect of the present disclosure.

Further, it is naturally understood that two or more of the matters described as the examples or the preferable scopes in the specification can be arbitrarily combined.

What is claimed is:

1. An optical glass,
wherein, on a mass basis,
a SiO₂ content is 1.00% or more,
a B₂O₃ content is 1.00% or more,
a CaO content is 1.00% or more,
a TiO₂ content is 15.00% or more,
a La₂O₃ content is 10.00% or more,
a total content of SiO₂ and B₂O₃ (SiO₂₊B₂O₃) is 22.00% or less,
a total content of TiO₂ and Nb₂O₅ (TiO₂+Nb₂O₅) is 20.00% or more,
a total content of MgO, CaO, SrO and BaO (MgO+CaO+SrO+BaO) is 18.00% or less,
a mass ratio of BaO content to the total content of MgO, CaO, SrO and BaO (BaO/(MgO+CaO+SrO+BaO)) is 0.50 or less,
a mass ratio of the TiO₂ content to the CaO content (TiO₂/CaO) is 1.50 or more and 15.00 or less, and
a mass ratio of the TiO₂ content to the total content of TiO₂ and Nb₂O₅ (TiO₂/(TiO₂+Nb₂O₅)) is 0.50 or more.

2. The optical glass according to claim 1,
wherein a mass ratio of the SiO₂ content to the total content of SiO₂ and B₂O₃ (SiO₂/(SiO₂+B₂O₃)) is 0.05 or more and 0.80 or less.

3. The optical glass according to claim 1,
wherein a total content of Li₂O, Na₂O and K₂O (Li₂O+Na₂O+K₂O) is 5.00% or less.

4. The optical glass according to claim 1,
wherein a total content of MgO, CaO, SrO, BaO and ZnO (MgO+CaO+SrO+BaO+ZnO) is 20.00% or less.

5. The optical glass according to claim 1,
wherein a mass ratio of the CaO content to the total content of MgO, CaO, SrO and BaO (CaO/(MgO+CaO+SrO+BaO)) is 0.50 or more.

6. The optical glass according to claim 1,
wherein a total content of Y₂O₃, La₂O₃ and Gd₂O₃ (Y₂O₃+La₂O₃+Gd₂O₃) is 10.00% or more.

7. The optical glass according to claim 1,
wherein a mass ratio of a Y₂O₃ content to the total content of Y₂O₃, La₂O₃ and Gd₂O₃ (Y₂O₃/(Y₂O₃+La₂O₃+Gd₂O₃)) is 0.00 or more and 0.80 or less.

8. The optical glass according to claim 1,
wherein a mass ratio of the total content of TiO₂ and Nb₂O₅ to the total content of Y₂O₃, La₂O₃ and Gd₂O₃ ((TiO₂+Nb₂O₅)/(Y₂O₃+La₂O₃+Gd₂O₃)) is 0.50 or more and 2.00 or less.

9. The optical glass according to claim 1,
wherein
a mass ratio of the SiO₂ content to the total content of SiO₂ and B₂O₃ (SiO₂/(SiO₂+B₂O₃)) is 0.20 or more and 0.80 or less,
a total content of Li₂O, Na₂O and K₂O (Li₂O+Na₂O+K₂O) is 5.00% or less,
a total content of MgO, CaO, SrO, BaO and ZnO (MgO+CaO+SrO+BaO+ZnO) is 20.00% or less,
a mass ratio of the CaO content to the total content of MgO, CaO, SrO and BaO (CaO/(MgO+CaO+SrO+BaO)) is 0.50 or more,
a total content of Y₂O₃, La₂O₃ and Gd₂O₃ (Y₂O₃+La₂O₃+Gd₂O₃) is 10.00% or more,
a mass ratio of the Y₂O₃ content to the total content of Y₂O₃, La₂O₃ and Gd₂O₃ (Y₂O₃/(Y₂O₃+La₂O₃+Gd₂O₃)) is 0.00 or more and 0.80 or less, and
a mass ratio of a total content of TiO₂ and Nb₂O₅ to the total content of Y₂O₃, La₂O₃ and Gd₂O₃ ((TiO₂+Nb₂O₅)/(Y₂O₃+La₂O₃+Gd₂O₃)) is 0.50 or more and 2.00 or less.

10. An optical element comprised of the optical glass according to claim 1.

11. A light guide plate comprised of the optical glass according to claim 1.

12. An image display device comprising:
an image display element, and
a light guide plate that guides light emitted from the image display element, wherein
the light guide plate is the light guide plate according to claim 11.
